(19) United States
(12) Patent Application Publication
(10) Pub. No.: US 2018/0300971 A1
(43) Pub. Date: Oct. 18, 2018

(54) ELECTRONIC AIRCRAFT DATA CAPTURE FOR REFUELING

(71) Applicant: QT Technologies, Dallas, TX (US)

(72) Inventors: David CONLEY, Dallas, TX (US); Wade CONLEY, Dallas, TX (US)

(21) Appl. No.: 15/918,861

(22) Filed: Mar. 12, 2018

Related U.S. Application Data
(60) Provisional application No. 62/469,957, filed on Mar. 10, 2017.

(51) Int. Cl. G07C 5/08

(52) U.S. Cl. CPC G07C 5/0866; G07C 5/0858

(57) ABSTRACT

A battery-powered, mobile device unit that is used to record arrival fuel amounts on an aircraft as well as the departure fuel amounts loaded on the aircraft and needed to safely fly the aircraft to its next destination. The mobile device unit gathers and records other information about the aircraft, fueling equipment and the person performing the fueling operation. The mobile device unit can capture Arrival Fuel Tank Volumes, Departure Fuel Tank Volumes, Aircraft Ship\Nose Number, and a Tail Number.

### CROSS-REFERENCE TO RELATED-APPLICATION

This application claims the priority benefit of U.S. Provisional Patent Application Ser. No. 62/469,957, filed Mar. 10, 2017, which is hereby incorporated herein by reference.

### TECHNICAL FIELD

The present invention generally relates to a fuel management system for users of fuel, such as aviation fleets.

### BACKGROUND OF THE INVENTION

Presently, in those instances where ground personnel are desirous of identifying particular aircraft for refueling purposes, it is necessary to manually observe and key in or otherwise record the information about the particular aircraft to be refueled. This can lead to errors. This same manual method is used for observing and recording fuel levels, such as from under-wing fuel gauges, also leading to errors.

For example, presently a “ticket” system is employed in which a fueler uses a paper ticket or a battery-powered mobile device to enter certain required information related to a fueling event and deliver that information to parties involved in the fueling event.

Accordingly, it can be seen that there exists a need for a better way for capturing identification data and fuel data of aircraft to be refueled. It is to the provision of solutions to this and other problems that the present invention is primarily directed.

### SUMMARY OF THE INVENTION

The present invention relates generally to an automated data capture of fuel levels and aircraft identification numbers as a way to provide for a quicker, more certain, more efficient way of observing and capturing data pertinent to refueling of aircraft. Advantageously, the present invention also provides for a method and apparatus which does so with fewer errors.

Briefly described, in an example form the present invention relates to a battery-powered, mobile device unit that is used to record arrival fuel amounts on the aircraft as well as the departure fuel amounts loaded on the aircraft and needed to safely fly the aircraft to its next destination. Additionally, the mobile device unit is adapted to gather and record other information about the aircraft, fueling equipment and the person performing the fueling operation. There are at least four important pieces of information that a user can capture with the mobile device unit:

1. The Arrival Fuel Tank Volumes;

2. The Departure Fuel Tank Volumes;

3. Aircraft Ship\Nose Number (Unique serial numbers for aircraft within the airline fleet); and

4. Tail Number (this is registered with the FAA and is unique in the world for that aircraft).

Preferably, the mobile device unit includes a camera and on-board (internal) character recognition software and/or hardware to allow the mobile device unit to be pointed at a data element of the aircraft and to capture the data. For example, the mobile device unit's camera can be pointed at the “Nose Number” and an image of the Nose Number thusly captured. The character recognition function of the mobile device unit is then used to turn that image into usable data for storage in the mobile device unit. Thus, by simply pointing the mobile device unit at the Nose Number on the aircraft and operating the controls of the mobile device unit, data representing the Nose Number of the aircraft can be electronically observed and recorded. This same electronic capture of Tail Number and fuel tank volume (at arrival and after refueling) can be accomplished with the mobile device unit.

The data so collected by the mobile device unit can be used to assist in the refueling of the aircraft. When the aircraft arrives for refueling, the Arrival Fuel Tank Volumes are collected in order to determine how much fuel is to be added based on the calculated fuel need to reach the destination. In other words, the amount of fuel that is needed on the aircraft to fly from the current location to the next location is determined and then the initial fuel on board (the Arrival Fuel Tank Volumes) is subtracted therefrom to determine the amount of fuel to be added. Thus, the Arrival Fuel Tank Volume is subtracted from the calculated fuel load to determine how much fuel needs to be added to the aircraft.

The data so collected by the mobile device unit also can be used to communicate Departure Fuel Tank Volumes (which indicates the total fuel on-board the aircraft after fueling) to the pilot and to the airline for various validations.

The data so collected by the mobile device unit also can be used to identify and record the Aircraft Ship\Nose Number & Tail Number.

Defined another way, in a preferred example form the present invention relates to a method and apparatus for electronically recognizing aircraft instrument data and recording the same. This is particularly useful for observing and recording fuel levels before and after re-fueling operations. Preferably, this is accomplished with a mobile device adapted to use image character recognition.

Defined another way, in a preferred example form the present invention relates to a method and apparatus for electronically recognizing aircraft identification data and recording the same. This is particularly useful for observing and recording nose/ship numbers and/or tail (FAA) numbers in connection with re-fueling operations. Preferably, this is accomplished with a mobile device adapted to use image character recognition.

### BRIEF DESCRIPTION OF THE DRAWING FIGURES

FIG. 1 is a schematic illustration of a mobile device according to an example form of the present invention and depicting the same in use with under-wing fuel gauges.

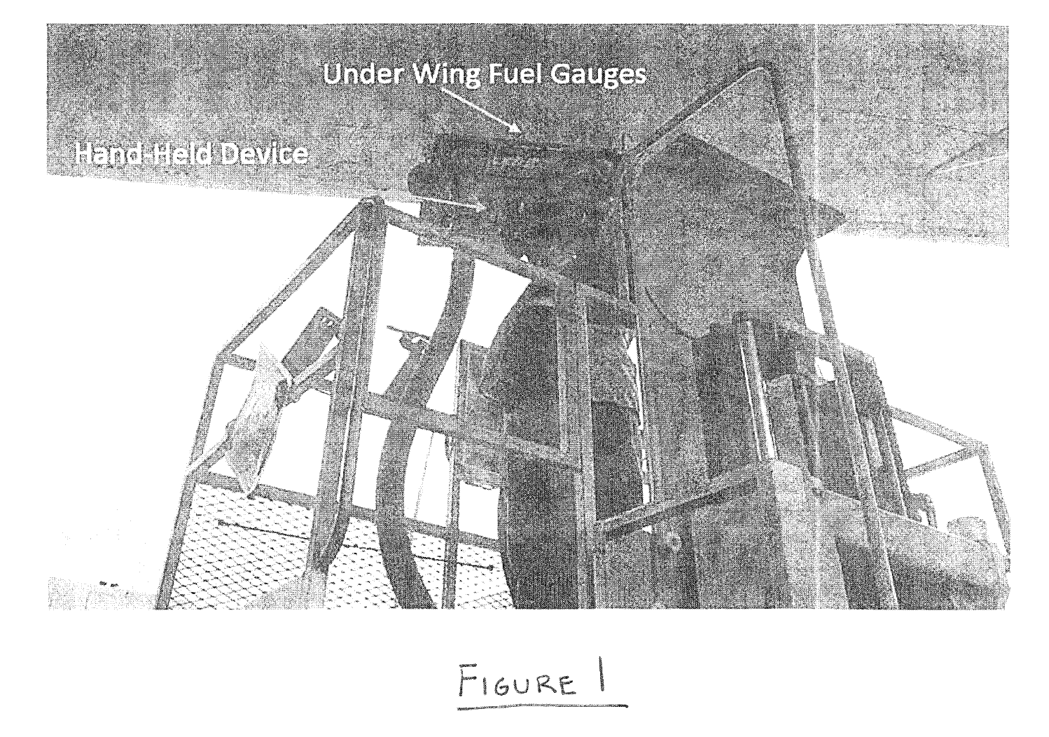

FIG. 2 is a schematic illustration of under-wing fuel gauges typically found on a particular type of aircraft (the example shown being a Boeing 747).

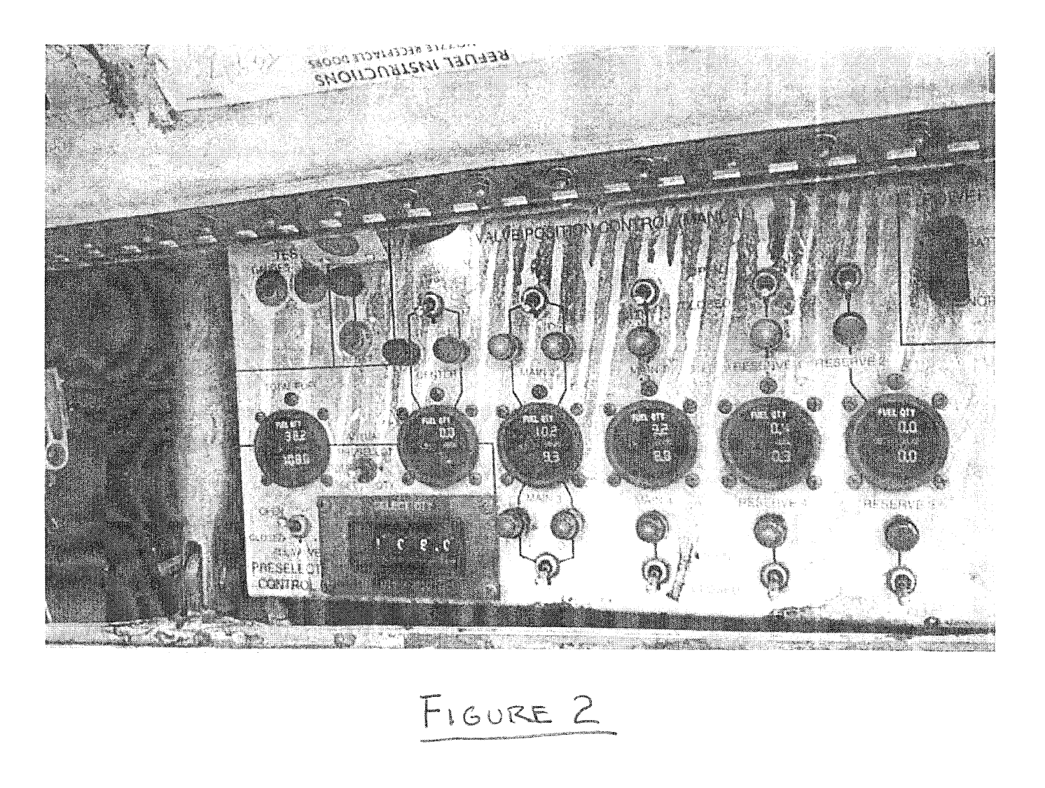

FIG. 3 is a schematic illustration of under-wing fuel gauges typically found on a particular type of aircraft (the example shown being an Airbus 340).

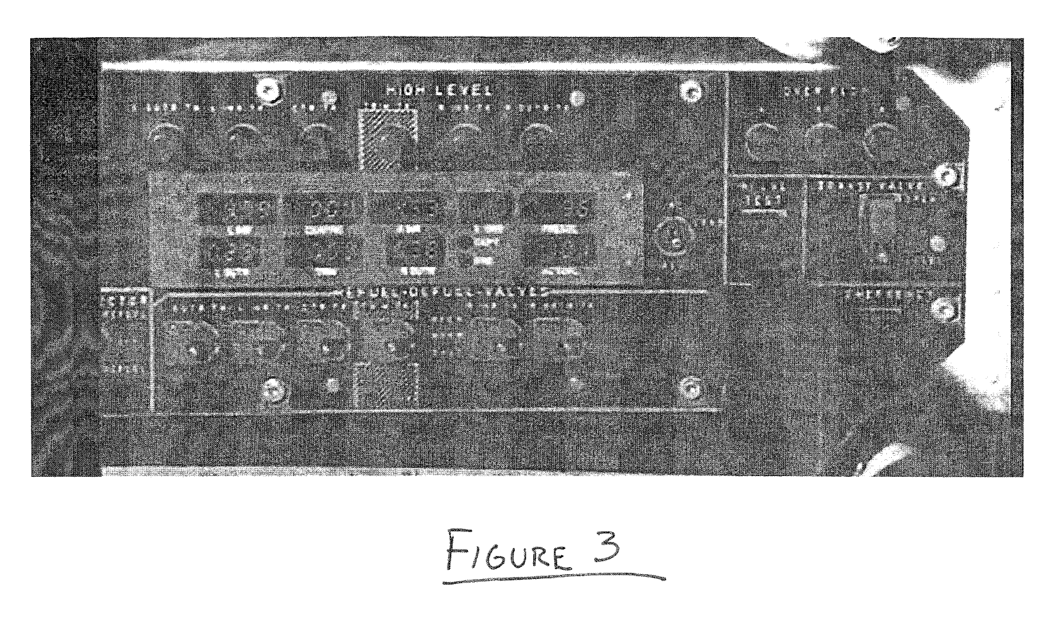

FIG. 4 is a schematic illustration of ship/nose numbers and tail (FAA) numbers on an aircraft of the sort that can be electronically recognized by the present invention.

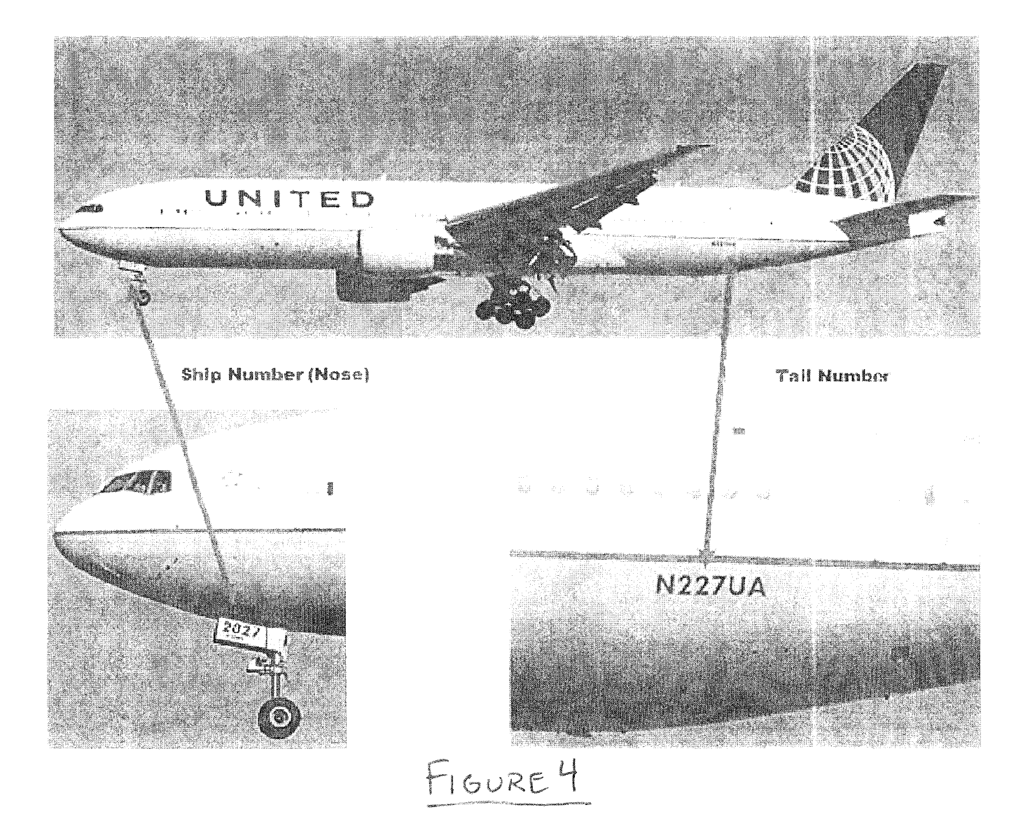

FIGS. 5A-5C are front, back, and side views of a mobile device according to a preferred example form of the present invention.

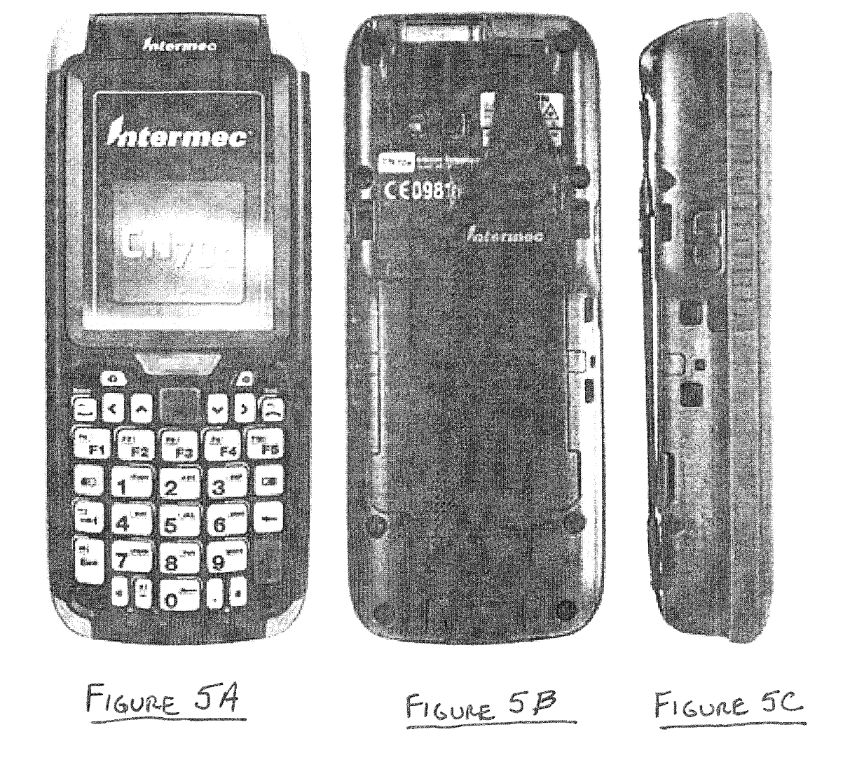

FIG. 6 is a schematic illustration of a first “screen shot” of the mobile device of FIGS. 1 and 5A-5C.

FIG. 7 is a schematic illustration of a second “screen shot” of the mobile device of FIGS. 1 and 5A-5C.

FIG. 8 is a schematic illustration of a third “screen shot” of the mobile device of FIGS. 1 and 5A-5C.

FIG. 9 is a schematic illustration of a fourth “screen shot” of the mobile device of FIGS. 1 and 5A-5C.

FIG. 10 is a schematic illustration of a fifth “screen shot” of the mobile device of FIGS. 1 and 5A-5C.

FIG. 11 is a schematic illustration of a sixth “screen shot” of the mobile device of FIGS. 1 and 5A-5C.

FIG. 12 is a schematic illustration of a seventh “screen shot” of the mobile device of FIGS. 1 and 5A-5C.

### DETAILED DESCRIPTION OF EXAMPLE EMBODIMENTS

The present invention relates to a method and apparatus for electronically recognizing aircraft instrument data and recording the same. This is particularly useful for observing and recording fuel levels before and after re-fueling operations. Preferably, this is accomplished with a mobile device adapted to use image character recognition. Defined another way, in a preferred example form the present invention relates to a method and apparatus for electronically recognizing aircraft identification data and recording the same. This is particularly useful for observing and recording nose/ship numbers and/or tail (FAA) numbers in connection with re-fueling operations. Preferably, this is accomplished with a mobile device adapted to use image character recognition.

In one example form the mobile device can comprise a Honeywell CN70e hand-held device. But those skilled in the art will recognize that other devices that meet the requirements for a Fueling Environment (Class I, Div II) can be employed.

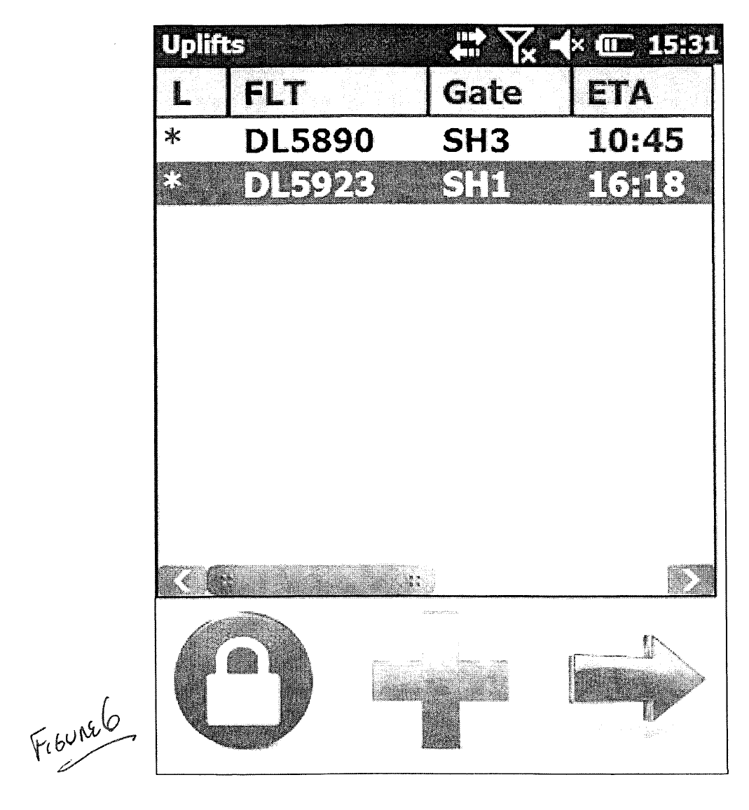

As shown in FIG. 6, the “Uplifts Page” displays the flights to be completed. The flights are sorted by Estimated Time of Departure (ETD). This page displays the flight number (FLT), Gate, Estimated Time of Arrival (ETA), Estimated Time of Departure (ETD), Fuel Load Quantity (QTY), and Destination (DST) of the listed flights. There is also a load indicator column (L) that displays an asterisk (*) when a fuel load has been assigned to the flight. These columns do not all fit on one screen, but can be viewed by scrolling right and left. If enough flights are loaded into the handheld, it is also possible to scroll up and down to view additional flights.

The flight list itself is sent to the handheld in one of two ways, Dispatch, or Dispatch All. With Dispatch All, every open flight within a predetermined time window is sent to all of the handhelds within that operation. This provides the freedom of allowing the fuelers to manage themselves, and is particularly useful in smaller operations that don't require the overhead/management of a higher traffic hub airport. Larger operations will use our Dispatch functionality to send each flight to the assigned fueler directly. When using Dispatch, the flight list on the Uplifts page will be blank until a flight is sent to the handheld using our web application. Multiple flights may be dispatched to a single fueler, but multiple handhelds cannot fuel the same flight with the same fueling transaction.

At the bottom of the page one can see the logout button, the additional features button, and the refresh/forward button. Pressing the plus+button opens a new page with a dropdown list with additional transaction types. The refresh/next button is a dynamic button that changes its functionality based on the fueler flight selection. The refresh process happens on its own, automatically refreshing every 60 seconds. With a flight selected, the button changes to a forward button, allowing the fueler to move into the selected flight and view the Flight Data page.

Quick Reference Instruction

I. To begin, select the flight to be fueled by tapping the line to highlight it. Once selected the flight should be highlighted blue.

a) An * in the Column indicates that a fuel load is available for that flight.

b) A user can scroll left/right to view additional flight information as well as the fuel load quantity.

c) A flight highlighted in yellow indicates 20 minutes or less to ETD.

II. Press the forward button to advance to the Flight Data page.

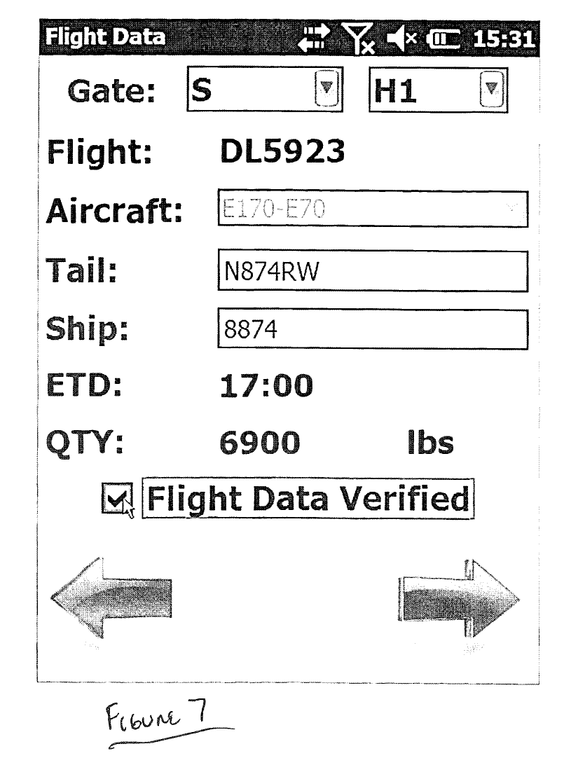

As shown in FIG. 7, the Flight Data page is used to ensure the fueler is fueling the correct aircraft. It displays the Gate, Flight Number, Aircraft Type, Tail, Fuel Load and ETD allowing the user to make sure everything matches the order before fueling. The fueler will then need to confirm the ship number of the aircraft by typing it into the Ship field. The user will not be able to move forward until the ship number is confirmed.

### Quick Reference Instruction

I. Verify the gate, aircraft type, and tail information are all correct.
II. Enter the correct Ship number

a) The user will not be able to proceed without the correct Ship number.

III. Press the forward button to advance to the Order Data page.

a) Notice the back button is now available to back out of the flight

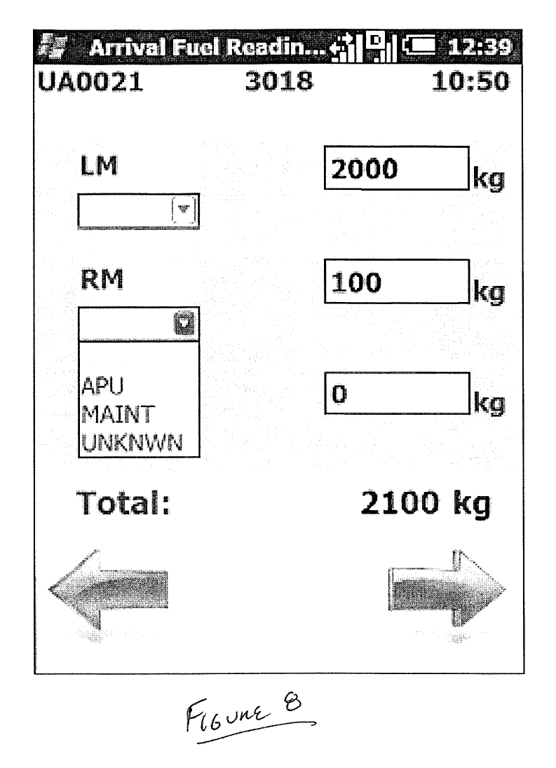

As shown in FIG. 8, the Arrival Fuel page asks the fueler to input the measured weight of the fuel already on board the aircraft before refueling begins. These values are most often entered directly from the aircraft's tank gauges located in the fuel panel on the aircraft.

This gives the application the information needed to calculate the amount of fuel to be added based on the fuel load sent by the airline. The tanks are programmed based on the aircraft type, and are labeled to match an FSR for that aircraft. If an aircraft has more than 3 tanks, the additional tanks are found on additional Arrival Fuel pages.

Based on airline standards, this fuel must fall within a specific weight and balance tolerance. If the values entered into the handheld fall outside this imbalance check, the handheld will display a message warning the fueler of an aircraft imbalance. This type of error can often be the result of a typo, and doesn't necessarily mean the aircraft is actually out of balance. In the event that the value was not entered incorrectly, and the arrival fuel levels are actually out of balance, once the error message has been acknowledged, a new drop down list will appear below the name of each tank, providing a selectable explanation of the imbalance. These options are APU, MAINT, or UNKNWN pictured above.

Each tank must have a value entered before moving forward, if a tank value is left blank, an error message will display informing the fueler to enter a value for the blank tank (even if that value is 0). Once each tank's value is entered, moving forward will bring the fueler to the Fuel Dispense page.

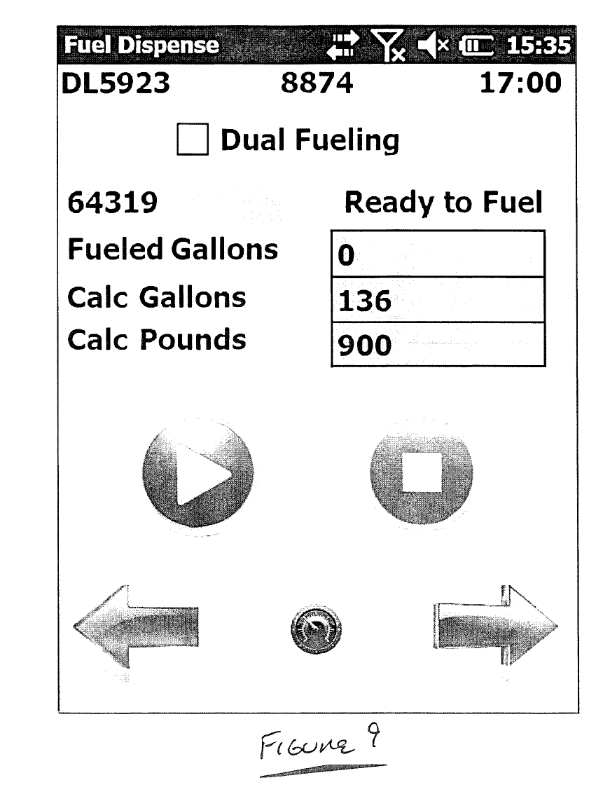

As shown in FIG. 9, on the Fuel Dispense page the handheld will connect to the FDU on the fueling equipment to automatically count the fuel as it's dispensed. This is called an automatic fueling. When first navigating to this page, a progress bar will display for the connection between the FDU and the handheld. When the connection has been established, the progress bar fills up and disappears. The selected equipment is highlighted based on the connection status. Green indicates a good connection, and Red indicates a failed connection. This is accompanied by a fueling status to the right. The Fueled Gallons field will automatically update as fuel is pumped. The Calc Gallons and Calc Pounds fields are calculated from the difference between the quantity of the fuel load and the quantity of the fuel entered on the Arrival Fuel page. The Dual Fueling checkbox at the top of the screen allows a second piece of equipment to be added to the fueling.

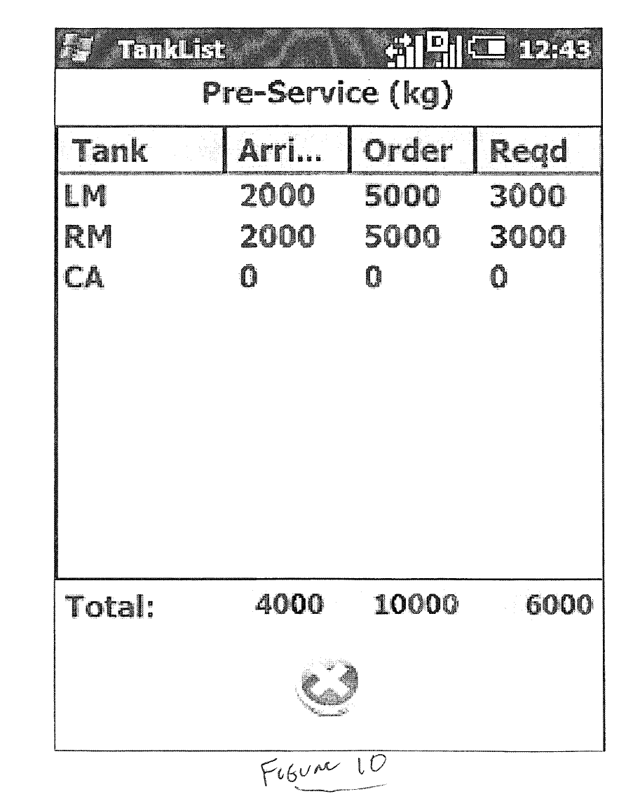

As shown in FIG. 10, between the navigation arrows a fuel gauge button can be touched to open the TankList page that displays the complete fuel load breakdown. This breakdown includes each aircraft tank, the values entered from the Arrival Fuel page, the desired distribution of the load, the required pounds to reach the desired distribution quantity, and a total of each at the bottom of the page. To return to the Fuel Dispense page, press the button at the bottom of the page.

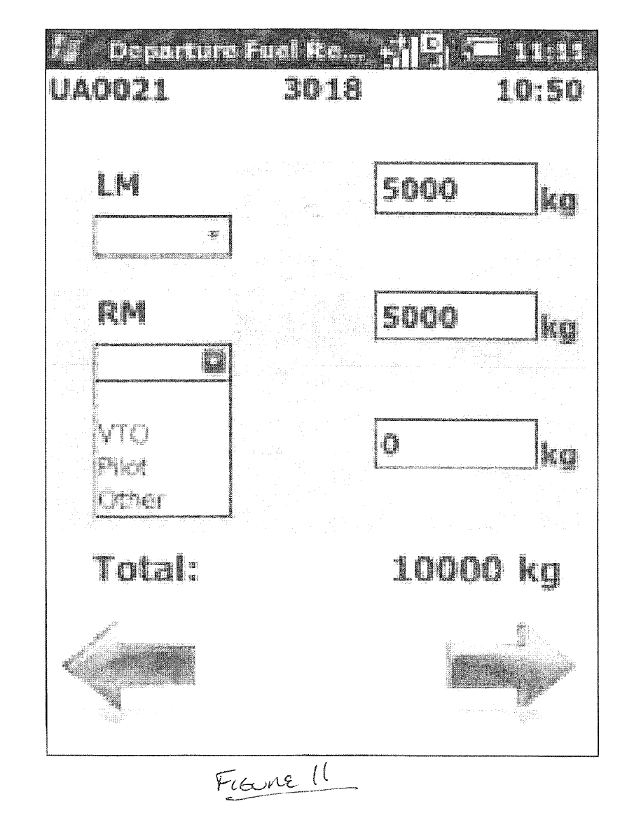

As shown in FIG. 11, the Departure Fuel page is very similar to the Arrival Fuel page. This time the user enters the measured weight of the fuel in the aircraft after refueling has been completed. The tanks list and imbalance tolerances are identical to the Arrival Fuel page.

However, the Departure Fuel page has an added check to verify that the weight entered falls within the airline's fuel distribution for that flight. If a value does end up outside the distribution values, the drop-down explanations are VTO, Pilot, and Other. Once the departure tank values have been entered the fueler moves forward to the Uplifts Summary. When fueling an aircraft with fuel caps, the user is prompted to confirm the status of the fuel cap.

### Quick Reference Instruction

I. Enter the post service (Departure) weight for each tank into their respective fields.

a) The Departure values will be checked against the official load breakdown (If available) for accuracy. If they don't match the user can use the drop down list options to provide a reason.

II. Press the forward button to advance to the Uplifts Summary page.

a) If the aircraft requires a fuel cap, the user is prompted to confirm that it has been reinstalled.

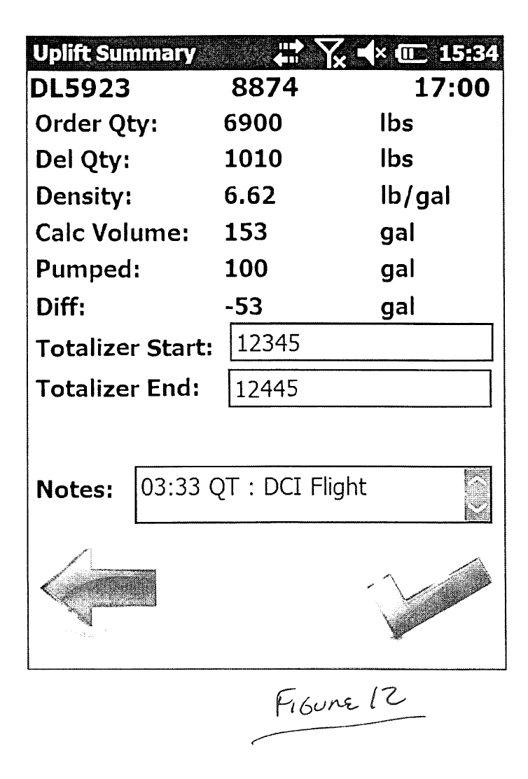

As shown in FIG. 12, the Uplifts Summary gives a final look at the details of the refueling. The flight reference information remains at the top with the Flight Number, Ship Number, and ETD. Also Displayed from Top to Bottom are the Order Quantity, the Delivery Quantity, Fuel Density, Calculated Volume, Pumped Volume, The Difference (Between Calculated and Pumped), as well as the Start and End totalizer values.

A difference is calculated based on the pumped fuel recorded by the handheld and the density calculated volume of the quantities entered into the Departure Fuel page. If this difference is greater than the fuel tolerance of the aircraft, the green check button will be greyed out and not useable until the tolerance is met.

The Totalizer values should always match the meter ticket. If they don't match for any reason, one can simply change the values to match in the handheld. This is done by touching inside either totalizer field to open a Totalizer Adjustment page. This page asks the user to confirm/change the End Totalizer and Pumped Fuel amount. The handheld then recalculates the Start Totalizer from these values.

So-called “mainline” flights are required to record the arrival and departure tank levels on the aircraft before and after fueling respectively. These steps typically aren't required when fueling the so-called “regional” carriers, so they have been removed from the handheld in favor of saving time. The removal of the Arrival Fuel page means that the fuel required to meet the official load on the Fuel Dispense page is not calculated. This change in workflow occurs naturally based on the flight number and regional carrier short code.

Optionally, the character recognition can be carried out locally, in the mobile device. Also optionally, the character recognition can be carried out remotely, such as centrally in a server or datacenter.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. An apparatus for electronically recognizing aircraft instrument data and recording the same comprises a mobile device adapted to use image character recognition for observing and recording fuel levels before and after re-fueling operations.

2. An apparatus for electronically recognizing aircraft identification data and recording the same comprises a mobile device adapted to use image character recognition for observing and recording nose/ship numbers and/or tail (FAA) numbers in connection with re-fueling operations.

3. An apparatus as claimed in claim 2 wherein the mobile device unit records Arrival Fuel Tank Volumes and The Departure Fuel Tank Volumes.

4. An apparatus as claimed in claim 2 wherein the mobile device unit records Aircraft Ship Numbers or Nose Numbers.
(Unique serial numbers for aircraft within the airline fleet); and

5. An apparatus as claimed in claim 2 wherein the mobile device unit records aircraft Tail Numbers.

6. An apparatus as claimed in claim 2 wherein the mobile device unit includes a camera and on-board (internal) character recognition software and/or hardware to allow the mobile device unit to be pointed at a data element of the aircraft and to capture the data.

7. An apparatus as claimed in claim 6 wherein the mobile device unit character recognition function of the mobile device unit is used to turn that image into usable data for storage in the mobile device unit.

8. An apparatus as claimed in claim 7 wherein the mobile device unit data so collected by the mobile device unit is used to assist in the refueling of the aircraft.
